(19) United States
(12) Patent Application Publication
(10) Pub. No.: US 2026/0352803 A1
(43) Pub. Date: Nov. 5, 2026

(54) BI-PREDICTIVE MERGE LIST FOR INTRA BLOCK COPY CODING

(71) Applicant: InterDigital CE Patent Holdings, SAS, Paris (FR)

(72) Inventors: Antoine Robert, Mézières sur Couesnon (FR); Karam Naser, Mouazé (FR); Ya Chen, Rennes (FR); Gagan Bihari Rath, Rennes (FR)

(73) Assignee: InterDigital CE Patent Holdings, SAS, Paris (FR)

(21) Appl. No.: 19/486,822

(22) PCT Filed: Jun. 17, 2024
(86) PCT No.: PCT/EP2024/066757

§ 371 Date: Nov. 21, 2025

(30) Foreign Application Priority Data
Jun. 30, 2023 (EP) 23306086.2

(51) Int. Cl. H04N 19/105; H04N 19/159; H04N 19/176

(52) U.S. Cl. CPC H04N 19/105; H04N 19/159; H04N 19/176

(57) ABSTRACT

Systems, devices, and methods are described herein for using a bi-predictive merge list for bi-predictive merge list for intra block copy (IBC) coding. An example method (e.g., for video decoding) may involve constructing an intra block copy (IBC) merge list comprising a plurality of bi-predictive candidates and uni-predictive candidates. A merge index that indicates a candidate from the plurality of bi-predictive candidates and uni-predictive candidates may be received in video data. The candidate may be selected based on the merge index. A coding block may be decoded based on the selected candidate.

### CROSS-REFERENCE TO RELATED APPLICATIONS

This application claims the benefit of European Provisional Patent Application No. EP23306086.2, filed Jun. 30, 2023, the contents of which are hereby incorporated by reference herein.

### BACKGROUND

Video coding systems may be used to compress digital video signals, e.g., to reduce the storage and/or transmission bandwidth needed for such signals. Video coding systems may include, for example, block-based, wavelet-based, and/or object-based systems.

### SUMMARY

Systems, devices, and methods are described herein for using a bi-predictive merge list for intra block copy (IBC) coding.

An example method (e.g., for video decoding) may involve constructing an intra block copy (IBC) merge list comprising a plurality of bi-predictive candidates and uni-predictive candidates. A merge index that indicates a candidate from the plurality of bi-predictive candidates and uni-predictive candidates may be received in video data. The candidate may be selected based on the merge index. A coding block may be decoded based on the selected candidate.

The IBC merge list may be constructed by adding a first uni-predictive candidate and a second uni-predictive candidate to the IBC merge list; determining a bi-predictive candidate based on the first uni-predictive candidate and the second uni-predictive candidate; and adding the bi-predictive candidate to the IBC merge list. The selected candidate may be the first uni-predictive candidate, the second uni-predictive candidate, or the bi-predictive candidate.

The coding block may be a first coding block. The method may determine that a block vector prediction merge mode is enabled for a second coding block. For the second coding block, a block vector prediction merge candidate may be generated based on a block vector part and a merge part. The IBC merge list may be generated by storing the block vector prediction merge candidate as a bi-predictive candidate in the IBC merge list.

The method may involve receiving a first indication of a first value. The first value may indicate that the candidate indicated by the first merge index is to be selected from the plurality of bi-predictive candidates and uni-predictive candidates. A second coding block may be obtained. The method may involve receiving a second merge index that indicates a first uni-predictive candidate, a third merge index that indicates a second uni-predictive candidate, and a second indication of a second value. The second value may indicate for the first uni-predictive candidate and the second uni-predictive candidate to be used to generate a bi-predictive candidate. The method may involve generating the bi-predictive candidate based on the second merge index and the third merge index. The second coding block may be decoded based on the bi-predictive candidate.

The bi-predictive candidates may be generated using at least one of: an IBC block vector prediction (BVP) mode, a BVP-merge mode, an IBC template matching (IBC-TM) merge mode, an IBC combined inter-intra prediction (IBC-CIIP) mode, an IBC merge mode with block vector difference (IBC-MBVD) mode, or an IBC geometric partitioning mode (IBC-GPM).

The method may involve receiving an indication of whether the plurality of bi-predictive candidates are able to be used. On a condition that the indication indicates that the plurality of bi-predictive candidates is not able to be used, the candidate may be selected based on the merge index comprises selecting the candidate, from the uni-predictive candidates, based on the merge index.

The merge index may be a first merge index. The IBC merge list may be stored. A second merge index that indicates a second candidate from the plurality of bi-predictive candidates and uni-predictive candidates may be received. A second coding block may be decoded based on the stored IBC merge list and the second merge index.

A video decoding device may include a processor configured to implement the steps of the method(s) described herein.

A method (e.g., for video encoding) may involve constructing bi-predictive intra block copy (IBC) merge list comprising a plurality of bi-predictive candidates and uni-predictive candidates. A coding block may be encoded based on a candidate from the plurality of bi-predictive candidates and uni-predictive candidates. The encoded coding block and an indication of a merge index of the candidate may be included in video data.

Constructing the IBC merge list comprising the plurality of bi-predictive candidates and uni-predictive candidates may involve adding a first uni-predictive candidate and a second uni-predictive candidate to the IBC merge list; determining a bi-predictive candidate based on the first uni-predictive candidate and the second uni-predictive candidate; and adding the bi-predictive candidate to the IBC merge list. The candidate may be the first uni-predictive candidate, the second uni-predictive candidate, or the bi-predictive candidate.

The coding block may be a first coding block. The method may involve determining that a block vector prediction merge mode is enabled for a second coding block. For the second coding block, a block vector prediction merge candidate may be generated based on a block vector part and a merge part. Constructing the IBC merge list comprising the plurality of bi-predictive candidates and uni-predictive candidates may involve storing the block vector prediction merge candidate as a bi-predictive candidate in the IBC merge list.

The merge index may be a first merge index. The method may involve including, in the first video data, a first indication of a first value. The first value may indicate that the candidate indicated by the first merge index is to be selected from the plurality of bi-predictive candidates and uni-predictive candidates. A second coding block may be encoded based on the candidate from the plurality of bi-predictive candidates and uni-predictive candidates. A bi-predictive candidate may be generated based on a first uni-predictive candidate and a second uni-predictive candidate. The second coding block may be encoded based on the bi-predictive candidate. The method may involve including, in second video data, a second merge index that indicates the first uni-predictive candidate, a third merge index that indicates the second uni-predictive candidate, and a second indication of a second value. The second value may indicate that the second coding block was encoded based on the bi-predictive candidate generated based on the first uni-predictive candidate and the second uni-predictive candidate.

The bi-predictive candidates may be generated using at least one of: an IBC block vector prediction (BVP) mode, a BVP-merge mode, an IBC template matching (IBC-TM) merge mode, an IBC combined inter-intra prediction (IBC-CIIP) mode, an IBC merge mode with block vector difference (IBC-MBVD) mode, or an IBC geometric partitioning mode (IBC-GPM).

An indication of whether the plurality of bi-predictive candidates are able to be used may be included in video data.

The IBC merge list may be stored. A second coding block may be encoded based on a second candidate in the stored IBC merge list. The encoded second coding block and a second merge index that indicates the second candidate may be included in video data.

A video encoding device may include a processor configured to implement the steps of the method(s) described herein.

A computer program product, which is stored on a non-transitory computer readable medium, may include program code instructions for implementing the steps of either of the above methods. A computer program may include program code instructions for implementing the steps of either of the above methods.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram showing an example block-based video encoder.

FIG. 3 is a diagram showing an example video decoder.

FIG. 4 is a diagram showing an example of a system in which various aspects and examples may be implemented.

FIG. 5 illustrates an example current coding tree unit (CTU) processing order and available reference samples.

FIG. 6 illustrates an example of an extended reference region for intra block copy (IBC) coding.

FIG. 7 illustrates example padding candidates for replacing a zero-vector in an IBC list.

### DETAILED DESCRIPTION

A detailed description of illustrative embodiments will now be described with reference to the various Figures. Although this description provides a detailed example of possible implementations, it should be noted that the details are intended to be exemplary and in no way limit the scope of the application.

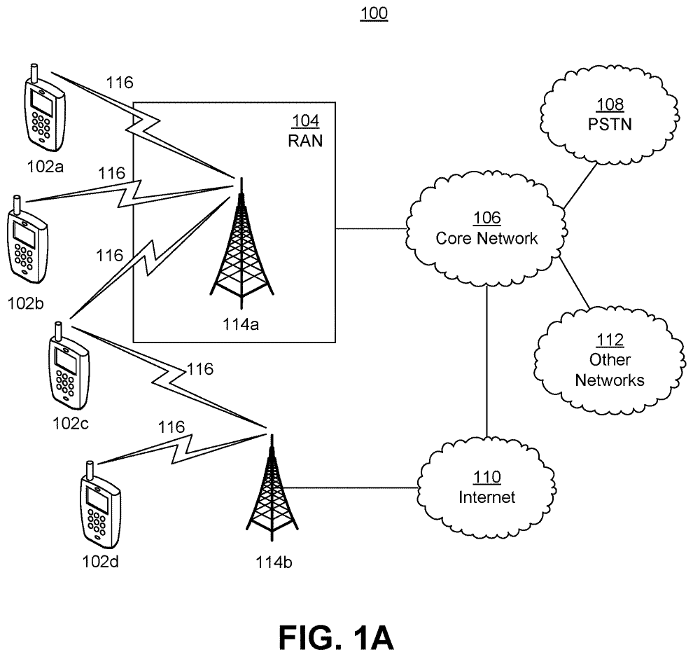

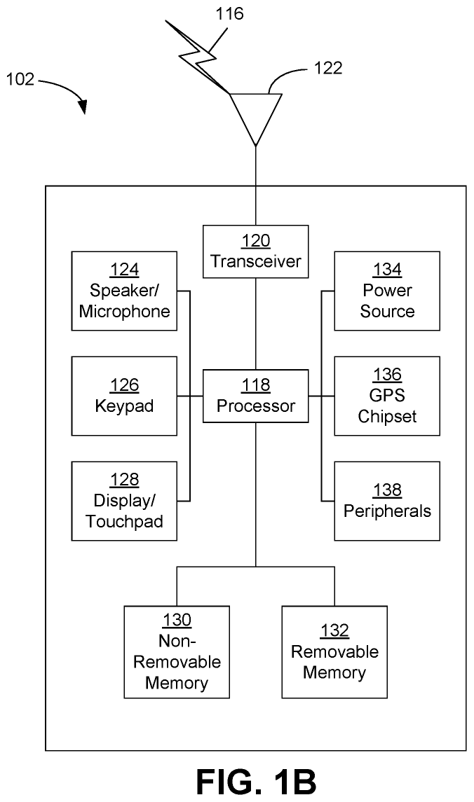

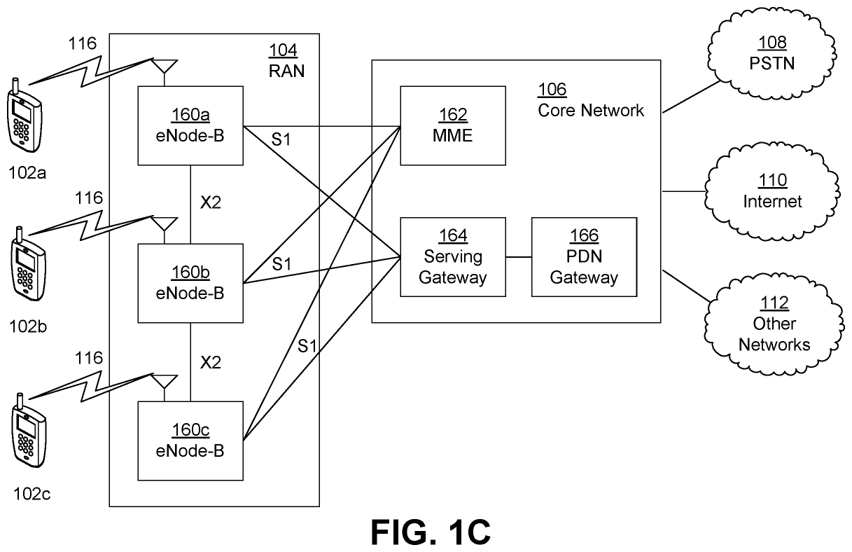

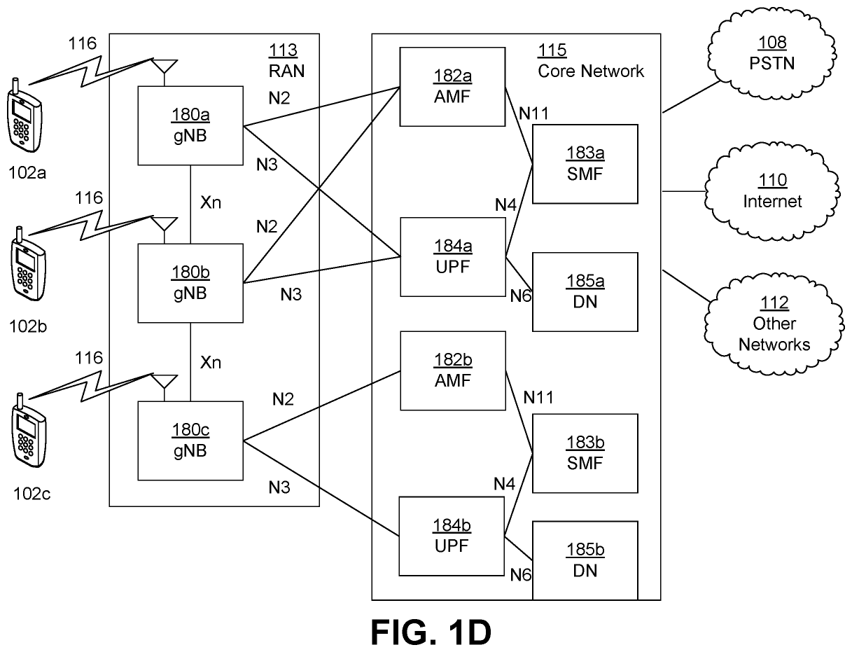

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

This application describes a variety of aspects, including tools, features, examples or embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects may be combined and interchanged to provide further aspects. Moreover, the aspects may be combined and interchanged with aspects described in earlier filings as well.

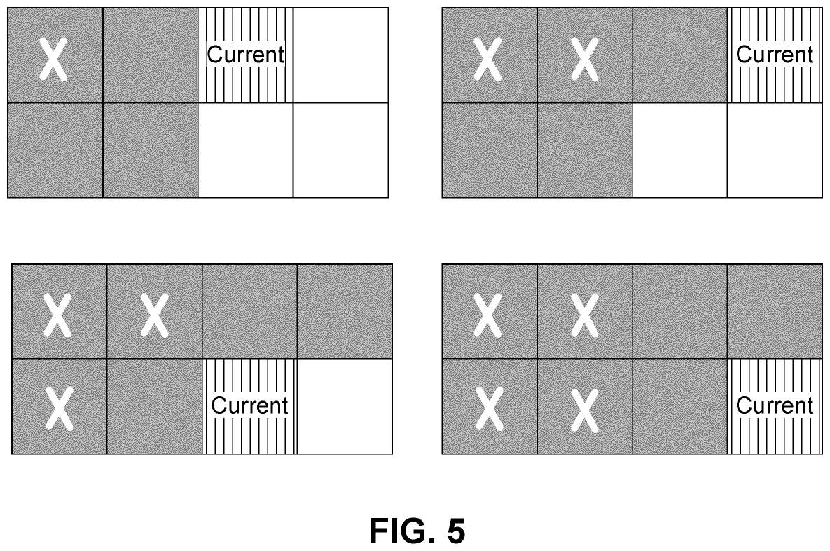

The aspects described and contemplated in this application may be implemented in many different forms. FIGS. 5-7 described herein may provide some embodiments, but other embodiments are contemplated. The discussion of FIGS. 5-7 does not limit the breadth of the implementations. At least one of the aspects generally relates to video encoding and decoding, and at least one other aspect generally relates to transmitting a bitstream generated or encoded. These and other aspects may be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably.

The terms HDR (high dynamic range) and SDR (standard dynamic range) may be used in this disclosure. Those terms often convey specific values of dynamic range to those of ordinary skill in the art. However, additional embodiments are also intended in which a reference to HDR is understood to mean “higher dynamic range” and a reference to SDR is understood to mean “lower dynamic range.” Such additional embodiments are not constrained by any specific values of dynamic range that might often be associated with the terms “high dynamic range” and “standard dynamic range.” Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

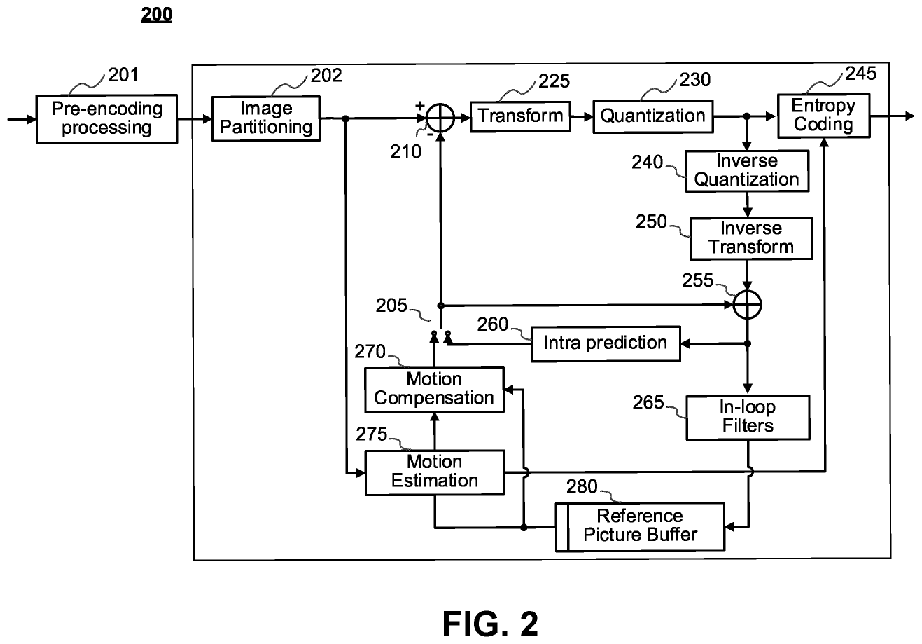

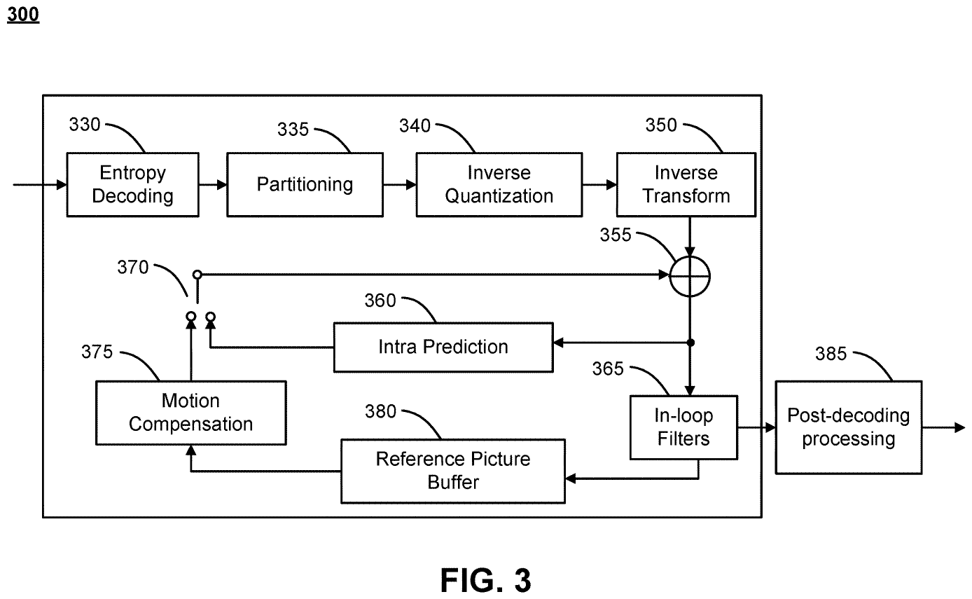

Various methods and other aspects described in this application may be used to modify modules, for example, intra prediction modules (260 and 360), of a video encoder 200 and decoder 300 as shown in FIG. 2 and FIG. 3, respectively. Moreover, the subject matter disclosed herein presents aspects that are not limited to VVC or HEVC, and may be applied, for example, to any type, format or version of video coding, whether described in a standard or a recommendation, whether pre-existing or future-developed, and extensions of any such standards and recommendations (e.g., including VVC and HEVC). Unless indicated otherwise, or technically precluded, the aspects described in this application may be used individually or in combination.

Various numeric values are used in examples described in the present application, such as table sizes, block sizes, pixel precision, indices, etc. These and other specific values are for purposes of describing examples and the aspects described are not limited to these specific values.

FIG. 2 is a diagram showing an example video encoder (e.g., an example block-based hybrid video encoder) 200. Variations of example encoder 200 are contemplated, but the encoder 200 is described below for purposes of clarity without describing all expected variations.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata may be associated with the pre-processing, and attached to the bitstream.

In the encoder 200, a picture is encoded by the encoder elements as described below. The picture to be encoded is partitioned (202) and processed in units of, for example, coding units (CUs). Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

FIG. 3 is a diagram showing an example of a video decoder 300. In example decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which may be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block may be obtained (370) from intra prediction (360) or motion-compensated prediction (i.e., inter prediction) (375). In-loop filters (365) are applied to the reconstructed image. The filtered image is stored at a reference picture buffer (380). For a given picture, the contents of the reference picture buffer 380 on the decoder 300 side may be identical to the contents of the reference picture buffer 280 on the encoder 200 side for the same picture.

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

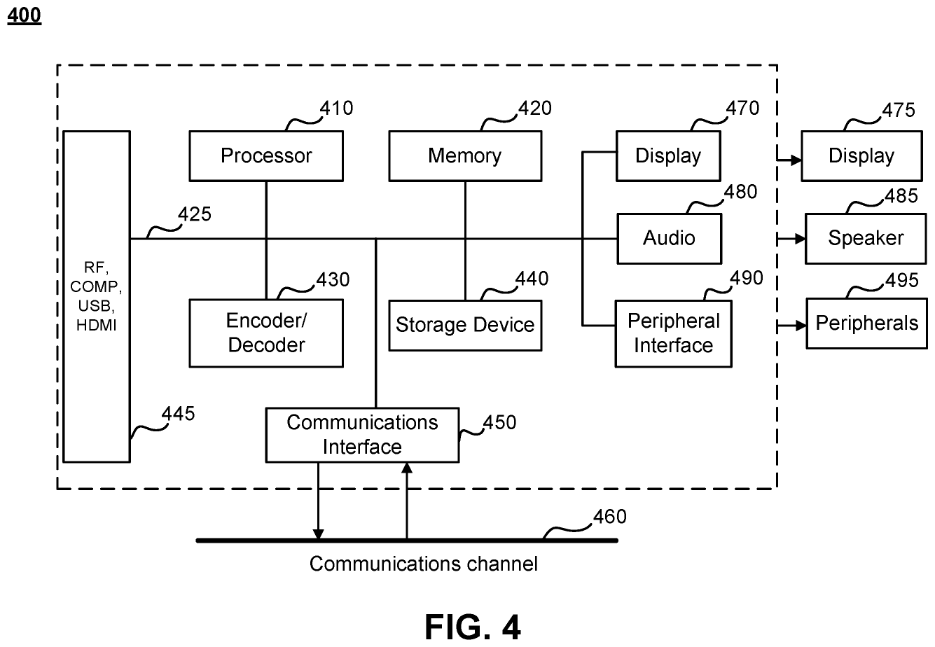

FIG. 4 is a diagram showing an example of a system in which various aspects and embodiments described herein may be implemented. System 400 may be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 400, singly or in combination, may be embodied in a single integrated circuit (IC), multiple ICs, and/or discrete components. For example, in at least one example, the processing and encoder/decoder elements of system 400 are distributed across multiple ICs and/or discrete components. In various embodiments, the system 400 is communicatively coupled to one or more other systems, or other electronic devices, via, for example, a communications bus or through dedicated input and/or output ports. In various embodiments, the system 400 is configured to implement one or more of the aspects described in this document.

The system 400 includes at least one processor 410 configured to execute instructions loaded therein for implementing, for example, the various aspects described in this document. Processor 410 can include embedded memory, input output interface, and various other circuitries as known in the art. The system 400 includes at least one memory 420 (e.g., a volatile memory device, and/or a non-volatile memory device). System 400 includes a storage device 440, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 440 can include an internal storage device, an attached storage device (including detachable and non-detachable storage devices), and/or a network accessible storage device, as non-limiting examples.

System 400 includes an encoder/decoder module 430 configured, for example, to process data to provide an encoded video or decoded video, and the encoder/decoder module 430 can include its own processor and memory. The encoder/decoder module 430 represents module(s) that may be included in a device to perform the encoding and/or decoding functions. As is known, a device can include one or both of the encoding and decoding modules. Additionally, encoder/decoder module 430 may be implemented as a separate element of system 400 or may be incorporated within processor 410 as a combination of hardware and software as known to those skilled in the art.

Program code to be loaded onto processor 410 or encoder/decoder 430 to perform the various aspects described in this document may be stored in storage device 440 and subsequently loaded onto memory 420 for execution by processor 410. In accordance with various embodiments, one or more of processor 410, memory 420, storage device 440, and encoder/decoder module 430 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 410 and/or the encoder/decoder module 430 is used to store instructions and to provide working memory for processing that is needed during encoding or decoding. In other embodiments, however, a memory external to the processing device (for example, the processing device may be either the processor 410 or the encoder/decoder module 430) is used for one or more of these functions. The external memory may be the memory 420 and/or the storage device 440, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as, for example, MPEG-2 (MPEG refers to the Moving Picture Experts Group, MPEG- 2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 400 may be provided through various input devices as indicated in block 445. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 4, include composite video.

In various embodiments, the input devices of block 445 have associated respective input processing elements as known in the art. For example, the RF portion may be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which may be referred to as a channel in certain embodiments, (iv) demodulating the down-converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 400 to other electronic devices across USB and/or HDMI connections. It is to be understood that various aspects of input processing, for example, Reed-Solomon error correction, may be implemented, for example, within a separate input processing IC or within processor 410 as necessary. Similarly, aspects of USB or HDMI interface processing may be implemented within separate interface ICs or within processor 410 as necessary. The demodulated, error corrected, and demultiplexed stream is provided to various processing elements, including, for example, processor 410, and encoder/decoder 430 operating in combination with the memory and storage elements to process the data stream as necessary for presentation on an output device.

Various elements of system 400 may be provided within an integrated housing, Within the integrated housing, the various elements may be interconnected and transmit data therebetween using suitable connection arrangement 425, for example, an internal bus as known in the art, including the Inter-IC (I2C) bus, wiring, and printed circuit boards.

The system 400 includes communication interface 450 that enables communication with other devices via communication channel 460. The communication interface 450 can include, but is not limited to, a transceiver configured to transmit and to receive data over communication channel 460. The communication interface 450 can include, but is not limited to, a modem or network card and the communication channel 460 may be implemented, for example, within a wired and/or a wireless medium.

Data is streamed, or otherwise provided, to the system 400, in various embodiments, using a wireless network such as a Wi-Fi network, for example IEEE 802.11 (IEEE refers to the Institute of Electrical and Electronics Engineers). The Wi-Fi signal of these examples is received over the communications channel 460 and the communications interface 450 which are adapted for Wi-Fi communications. The communications channel 460 of these embodiments is typically connected to an access point or router that provides access to external networks including the Internet for allowing streaming applications and other over-the-top communications. Other embodiments provide streamed data to the system 400 using a set-top box that delivers the data over the HDMI connection of the input block 445. Still other embodiments provide streamed data to the system 400 using the RF connection of the input block 445. As indicated above, various embodiments provide data in a non-streaming manner. Additionally, various embodiments use wireless networks other than Wi-Fi, for example a cellular network or a Bluetooth network.

The system 400 can provide an output signal to various output devices, including a display 475, speakers 485, and other peripheral devices 495. The display 475 of various embodiments includes one or more of, for example, a touchscreen display, an organic light-emitting diode (OLED) display, a curved display, and/or a foldable display. The display 475 may be for a television, a tablet, a laptop, a cell phone (mobile phone), or other device. The display 475 can also be integrated with other components (for example, as in a smart phone), or separate (for example, an external monitor for a laptop). The other peripheral devices 495 include, in various examples of embodiments, one or more of a stand-alone digital video disc (or digital versatile disc) (DVR, for both terms), a disk player, a stereo system, and/or a lighting system. Various embodiments use one or more peripheral devices 495 that provide a function based on the output of the system 400. For example, a disk player performs the function of playing the output of the system 400.

In various embodiments, control signals are communicated between the system 400 and the display 475, speakers 485, or other peripheral devices 495 using signaling such as AV. Link, Consumer Electronics Control (CEC), or other communications protocols that enable device-to-device control with or without user intervention. The output devices may be communicatively coupled to system 400 via dedicated connections through respective interfaces 470, 480, and 490. Alternatively, the output devices may be connected to system 400 using the communications channel 460 via the communications interface 450. The display 475 and speakers 485 may be integrated in a single unit with the other components of system 400 in an electronic device such as, for example, a television. In various embodiments, the display interface 470 includes a display driver, such as, for example, a timing controller (T Con) chip.

The display 475 and speakers 485 can alternatively be separate from one or more of the other components, for example, if the RF portion of input 445 is part of a separate set-top box. In various embodiments in which the display 475 and speakers 485 are external components, the output signal may be provided via dedicated output connections, including, for example, HDMI ports, USB ports, or COMP outputs.

The embodiments may be carried out by computer software implemented by the processor 410 or by hardware, or by a combination of hardware and software. As a non-limiting example, the embodiments may be implemented by one or more integrated circuits. The memory 420 may be of any type appropriate to the technical environment and may be implemented using any appropriate data storage technology, such as optical memory devices, magnetic memory devices, semiconductor-based memory devices, fixed memory, and removable memory, as non-limiting examples. The processor 410 may be of any type appropriate to the technical environment, and can encompass one or more of microprocessors, general purpose computers, special purpose computers, and processors based on a multi-core architecture, as non-limiting examples.

Various implementations involve decoding. “Decoding”, as used in this application, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application, for example, constructing a bi-predictive intra block copy (IBC) merge list comprising a plurality of bi-predictive candidates; determining, from video data, a merge index that indicates a bi-predictive candidate from the plurality of bi-predictive candidates; and decoding a coding block based on the bi-predictive candidate indicated by the merge index, etc.

As further embodiments, in one example “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application, for example, constructing a bi-predictive intra block copy (IBC) merge list comprising a plurality of bi-predictive candidates; encoding a coding block based on a bi-predictive candidate from the plurality of bi-predictive candidates; and including, in video data, the encoded coding block and a flag indicating a merge index of the bi-predictive candidate, etc.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that syntax elements as used herein, for example, DUAL_TREE, Bi_IBC_flag, IBC_merge_index_number_minus_1, etc., are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein may be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus may be implemented in, for example, appropriate hardware, software, and firmware. The methods may be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment,” “an embodiment,” “an example,” “one implementation” or “an implementation,” as well as other variations thereof, means that a particular feature, structure, characteristic, and so forth described in connection with the embodiment is included in at least one embodiment. Thus, the appearances of the phrase “in one embodiment,” “in an embodiment,” “in an example,” “in one implementation,” or “in an implementation”, as well any other variations, appearing in various places throughout this application are not necessarily all referring to the same embodiment or example.

Additionally, this application may refer to “determining” various pieces of information. Determining the information can include one or more of, for example, estimating the information, calculating the information, predicting the information, or retrieving the information from memory. Obtaining may include receiving, retrieving, constructing, generating, and/or determining.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in some embodiments the encoder signals (e.g., to a decoder) a size index of a filter or set of filters, etc. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling may be used without transmitting (implicit signaling) to simply allow the decoder to know and select the particular parameter. By avoiding transmission of any actual functions, a bit savings is realized in various embodiments. It is to be appreciated that signaling may be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations may produce a variety of signals formatted to carry information that may be, for example, stored or transmitted. The information can include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

Many embodiments are described herein. Features of embodiments may be provided alone or in any combination, across various claim categories and types. Further, embodiments may include one or more of the features, devices, or aspects described herein, alone or in any combination, across various claim categories and types. For example, features described herein can be implemented in a bitstream or signal that includes information generated as described herein. The information can allow a decoder to decode a bitstream, the encoder, bitstream, and/or decoder according to any of the embodiments described. For example, features described herein can be implemented by creating and/or transmitting and/or receiving and/or decoding a bitstream or signal. For example, features described herein can be implemented a method, process, apparatus, medium storing instructions, medium storing data, or signal. For example, features described herein can be implemented by a TV, set-top box, cell phone, tablet, or other electronic device that performs decoding. The TV, set-top box, cell phone, tablet, or other electronic device can display (e.g., using a monitor, screen, or other type of display) a resulting image (e.g., an image from residual reconstruction of the video bitstream). The TV, set-top box, cell phone, tablet, or other electronic device can receive a signal including an encoded image and perform decoding.

Feature(s) associated with intra block copy (IBC) coding are provided herein.

IBC is a tool that may be used for screen content coding (SCC). IBC may improve (e.g., significantly improve) the coding efficiency of screen content materials. IBC mode may be implemented as a block level coding mode. Block matching (BM) may be performed at the encoder. Block matching may be performed to find a block vector (BV) (e.g., the optimal BV) or a motion vector for a coding unit (CU) (e.g., each CU). A BV may indicate the displacement from the current block to a reference block. The reference block may have been reconstructed (e.g., already reconstructed) inside the current picture. The luma BV of an IBC-coded CU may be represented with integer precision. The chroma BV may be represented with (e.g., rounded to) integer precision. If IBC is combined with adaptive motion vector resolution (AMVR), the IBC mode may switch between 1-pel and 4-pel (e.g., 1-pixel or 4-pixel) motion vector precisions. An IBC-coded CU may be treated as a third prediction mode (e.g., in addition to intra or inter prediction modes). The IBC mode may be applicable to CUs with a width and a height (e.g., both width and height) smaller than or equal to 64 luma samples.

At the CU level, IBC mode may be signaled with a flag. IBC mode may be signaled as IBC advanced motion vector prediction (AMVP) mode or IBC skip/merge mode, as described herein.

Feature(s) associated with an IBC skip/merge mode are provided herein. In IBC skip/merge mode, a merge candidate index may be used to indicate which block vectors (e.g., in a list from neighboring candidate IBC coded blocks) is used to predict the current block. The merge list may include spatial, history-based motion vector predictor (HMVP), and/or pairwise candidates.

Feature(s) associated with IBC AMVP mode are provided herein. In IBC AMVP mode, a block vector difference may be coded (e.g., in the same way as a motion vector difference). The block vector prediction may use one or more (e.g., two) candidates as predictors. The candidates may be picked from the merge list (e.g., with minimum cost, if IBC coded). If a neighbor (e.g., either neighbor) is not available, a default block vector may be used as a predictor. A flag may be signaled to indicate the block vector predictor index.

Feature(s) associated with an IBC reference region are provided herein.

The IBC may consider the reconstructed portion (e.g., only the reconstructed portion) of the predefined area, including the region of the current coding tree unit (CTU) and some region of the left CTU (e.g., to limit memory consumption and decoder complexity). FIG. 5 illustrates the reference region of IBC mode. A block (e.g., each block) in FIG. 5 may represent a 64×64 luma sample unit.

FIG. 5 illustrates a current CTU processing order and available reference samples in a current and left CTU. Depending on the location of the current CU location within the current CTU, one or more of the following may apply. If the current block is in (e.g., falls into) the top-left 64×64 block of the current CTU, the current block may refer to the reference samples in the bottom-right 64×64 blocks of the left CTU (e.g., in addition to the already reconstructed samples in the current CTU) using IBC mode. The current block may refer to the reference samples in the bottom-left 64×64 block of the left CTU and/or the reference samples in the top-right 64×64 block of the left CTU (e.g., using IBC mode).

If the current block falls into the top-right 64×64 block of the current CTU, then in addition to the already reconstructed samples in the current CTU, if the luma location (0, 64) relative to the current CTU has not yet been reconstructed, the current block can also refer to the reference samples in the bottom-left 64×64 block and bottom-right 64×64 block of the left CTU, using IBC mode; otherwise, the current block can also refer to reference samples in bottom-right 64×64 block of the left CTU.

If the current block is in (e.g., falls into) the bottom-left 64×64 block of the current CTU, and if the luma location (64, 0) relative to the current CTU has not yet been reconstructed, the current block may refer to the reference samples in the top-right 64×64 block and bottom-right 64×64 block of the left CTU (e.g., in addition to the already reconstructed samples in the current CTU) using IBC mode. Otherwise (e.g., if the luma location (64, 0) relative to the current CTU has been reconstructed), the current block may refer to the reference samples in the bottom-right 64×64 block of the left CTU (e.g., using IBC mode).

If the current block is in (e.g., falls into) the bottom-right 64×64 block of the current CTU, the current block may refer (e.g., only refer) to the already reconstructed samples in the current CTU (e.g., using IBC mode). This may allow the IBC mode to be implemented using local on-chip memory for hardware implementations.

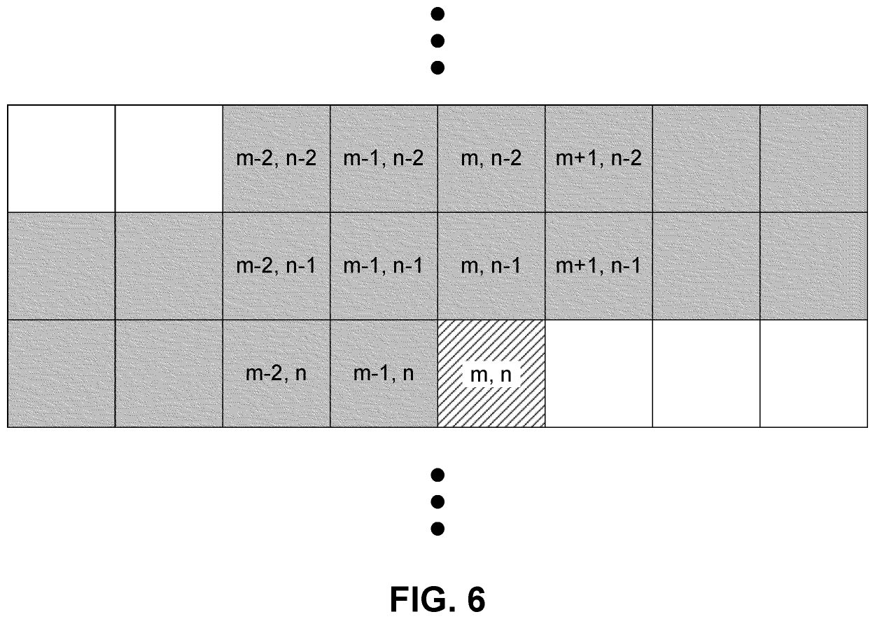

The reference region for IBC may be extended to one or more (e.g., two) CTU rows above the CTU being processed (e.g., by the encoder or the decoder). FIG. 6 illustrates an example extended reference region for IBC. FIG. 6 illustrates the reference area for coding CTU (m, n). For example, for CTU (m, n) to be coded, the reference area may include CTUs with indices (m-2, n-2) . . . (W, n-2), (0, n-1) . . . (W, n-1), (0,n) . . . and (m, n), where W denotes the maximum horizontal index within the current tile, slice, or picture. The per-sample block vector search range (e.g., sometimes referred to as local search range) may be (e.g., may be limited to) [−(C<<1), C>>2] horizontally and [−C, C>>2] vertically (e.g., to adapt to the reference area extension), where C denotes the CTU size.

Feature(s) associated with IBC merge/AMVP list construction are provided herein. The IBC merge/AMVP list construction may be modified as follows: if (e.g., only if) an IBC merge/AMVP candidate is valid (e.g., the candidate BV is, at least partially, in the reference region), the candidate may be inserted into the IBC merge/AMVP candidate list; the above-right, bottom-left, and above-left spatial candidates, and one pairwise average candidate may be added into the IBC merge/AMVP candidate list; template based adaptive reordering (ARMC-TM) may be applied to the IBC merge list.

The HMVP table size for IBC may be increased (e.g., to 25 entries). One or more (e.g., up to 20) IBC merge candidates may be derived (e.g., with full pruning). The IBC merge candidate(s) may be (e.g., may then be) reordered (e.g., together). The first one or more (e.g., 6) candidates with the lowest template matching costs may (e.g., after reordering) be selected as the final candidates in the IBC merge list.

The candidates from zero vectors to pad the IBC merge/AMVP list may be replaced with a set of block vector prediction (BVP) candidates (e.g., located in the IBC reference region). A zero vector may be invalid as a block vector in IBC merge mode. The zero vector may be discarded as a BVP in the IBC candidate list.

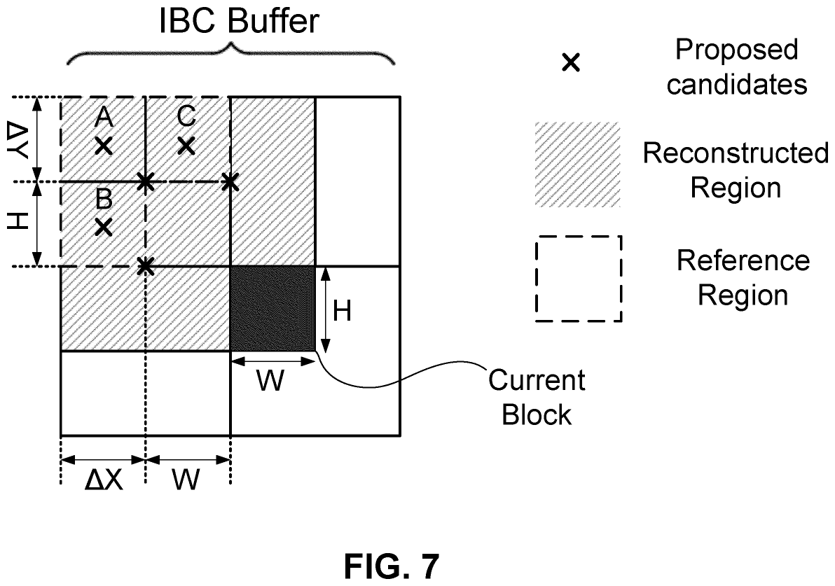

FIG. 7 illustrates example padding candidates for the replacement of the zero-vector in the IBC list. One or more (e.g., three) candidates may be located on the nearest corners of the reference region. One or more (e.g., three additional) candidates may be determined in the middle of the three sub-regions (labeled A, B, and C in FIG. 7). Coordinates of the sub-regions may be determined by the width and the height of the current block and the AX and AY parameters, as illustrated in FIG. 7.

Feature(s) associated with IBC with template matching are provided herein.

Template matching (TM)-based motion search and refinement may be applied to the case of IBC. For example, an IBC-TM merge mode may be used. The IBC-TM merge mode may involve a merge candidate list for BV prediction. The merge candidate list may be different from the candidate list used in regular IBC merge mode. The candidates may be selected using pruning. A motion distance between the candidates may be used (e.g., as in the regular TM merge mode). The zero motion candidates may have been replaced by MVs at (−W, 0), (0,−H), (−W,−H).

In the IBC-TM merge mode, the selected candidates may be refined with template matching. The TM-merge flag may be signaled to indicate the template matching merge IBC mode.

In the IBC-TM AMVP mode, one or more (e.g., up to 3) candidates may be selected from the IBC-TM merge list. The candidates (e.g., each candidate) may be refined using template matching (e.g., according to the usual template matching method). The candidates may be sorted according to their resulting TM cost.

If TM refinement is used for IBC, the TM refinement may be performed at integer pel (e.g., pixel) position. In IBC-TM AMVP mode, TM refinement may be performed either at integer or 4-pel (e.g., 4-pixel) precision (e.g., depending on the AMVR value). The refinement may be performed within the existing IBC reference region.

Feature(s) associated with interactions between IBC and other coding tools are provided herein.

One or more of the following interactions between IBC mode and other inter coding tools (e.g., pairwise merge candidate, HMVP, combined intra/inter prediction mode (CIIP), merge mode with motion vector difference (MMVD), and/or geometric partitioning mode (GPM)) may occur.

IBC may be used with a pairwise merge candidate and HMVP. For example, a new pairwise IBC merge candidate may be generated by averaging two IBC merge candidates. For HMVP, IBC motion may be inserted into a history buffer for future referencing.

IBC may not be used in combination with some inter tools (e.g., affine motion). IBC may be used in combination with CIIP, MMVD, GPM, and/or the like. IBC may not be allowed for chroma coding blocks (e.g., if a DUAL_TREE partition is used).

In some examples, the current picture may not be included as one of the reference pictures in the reference picture list 0 for IBC prediction. The derivation process of motion vectors for IBC mode may exclude one or more (e.g., all) neighboring blocks in inter mode (e.g., and vice versa).

One or more of the following IBC design aspects may be applied (e.g., may be applied in VVC): IBC may share the same process as in regular MV merge (e.g., including with pairwise merge candidate and HMVP); IBC may disallow temporal motion vector predictor (TMVP) and/or zero vector (e.g., because they are invalid for IBC mode); a separate HMVP buffer (e.g., with 5 candidates each) may be used for MV and IBC (e.g., conventional MV and IBC BV); for deblocking, IBC may be handled as an inter mode; if the current block is coded using IBC prediction mode, AMVR may not use quarter-pel (e.g., ¼-pixel) nor half-pel (e.g., ½-pixel); AMVR may be signaled to indicate (e.g., only indicate) whether BV is inter-pel (e.g., inter-pixel) or 4 integer-pel (e.g., 4 inter-pixel); the number of IBC merge candidates may be signaled in a slice header (e.g., separately from the numbers of regular, subblock, and/or geometric merge candidates).

Feature(s) associated with bi-predictive IBC are provided herein.

Bi-predictive IBC may enhance the coding performance of IBC for natural and/or screen content. IBC (e.g., uni-predictive IBC) may generate prediction samples with a BV (e.g., only one BV). The prediction accuracy of IBC may be improved. IBC with one or more (e.g., two) BVs (e.g., bi-predictive IBC) may be used instead of uni-predictive IBC.

One or more types of bi-predictive IBCs may be used.

In a first example (e.g., referred to as IBC BVP-merge mode), one or more (e.g., the two required) BVs may be derived from IBC BVP mode and IBC merge mode (e.g., similar to the MV derivation of AMVP-merge mode). One or more (e.g., two) different indices for the IBC BVP and the IBC merge candidates may be signaled from the encoder to the decoder (e.g., which may be different from the AMVP-merge mode).

In a second example (e.g., referred to as bi-predictive IBC merge mode), one or more (e.g., the two required) BVs may be derived from the IBC merge candidate list. One or more (e.g., two) different IBC merge indices may be used to derive the BVs. The two indices may be signaled from the encoder to the decoder. The target of the bi-predictive IBC merge mode may include IBC-regular merge and/or IBC merge mode with block vector difference (IBC-MBVD) and IBC geometric partitioning mode (IBC-GPM) (e.g., which may be enabled for screen content by default). In this second example, bi-predictive IBC-MBVD may be enabled in natural and screen content. Bi-predictive IBC-GPM is enabled in screen content (e.g., only in screen content).

Feature(s) associated with merge candidate list construction are provided herein. The existing IBC merge candidate list construction scheme for uni-predictive IBC merge mode may be reused for IBC BVP-merge mode and/or bi-predictive IBC merge mode, as described herein.

Feature(s) associated with BV refinement are provided herein. IBC with template matching may be enabled for IBC BVP-merge mode and/or bi-predictive IBC merge mode, as described herein.

Feature(s) associated with compensation are provided herein. One or more final IBC prediction samples (e.g., with a simple (1:1) average of bi-predictive IBC samples) may be generated in IBC BVP-merge mode and/or bi-predictive IBC merge mode.

Feature(s) associated with BV storage are provided herein. The one or more (e.g., two) BVs may be stored in BV storage (e.g., if the bi-predictive IBC is enabled).

Feature(s) associated with signaling are provided herein. A control flag of bi-predictive IBC (e.g., Bi_IBC_flag) may be signaled (e.g., at a slice level in an I slice). The control flag may not be signaled in B and P slices. Reconstructed-Reordered IBC may be disabled if the bi-predictive IBC is enabled.

IBC BVP-merge mode and/or bi-predictive IBC merge mode may be enabled in chroma component blocks of a single tree.

A bi-predictive merge list for IBC may be constructed by: using features associated with the AMVP and/or merge modes (e.g., the regular AMVP and merge modes); using bi-predictive BVP-merge candidates that have been generated; and/or signaling the number of merge indices used.

A Bi-predictive merge list may avoid signaling of a plurality of (e.g., two) distinct merge indices.

Bi-predictive IBC merge candidates may be obtained through a plurality of (e.g., two) distinct uni-predictive candidates from the IBC merge list (e.g., which may involve signaling 2 merge indices). To avoid signaling multiple (e.g., two) indices, bi-predictive candidates may be obtained (e.g., directly) from a bi-predictive merge list.

Feature(s) associated with an IBC merge list (e.g., similar to the merge list in inter coding mode) are provided herein. Techniques for constructing a bi-predictive IBC merge list may be similar to those used in inter coding mode. For example, in the inter AMVP mode, one or more (e.g., several) uni-predictive candidates may be tested. A combination of the two best candidates may be used as the bi-predictive candidate. If the bi-predictive candidate is selected through rate distortion optimization (RDO) as the best candidate, the candidate may be stored as bi-predictive. The inter merge list may be constructed by using some stored information (e.g., which may be uni- or bi-predictive information).

In the IBC case, a similar technique may be used. For example, the IBC BVP mode may test several uni-predictive candidates (e.g., as it is actually performed) to isolate the best candidate. The IBC BVP mode may (e.g., also) test the bi-predictive case by using (e.g., combining) the two best uni-predictive candidates. If the bi-predictive candidate is selected as the best candidate (e.g., based on RDO), the bi-predictive candidate may be stored as bi-predictive information (e.g., which may be reusable by the IBC merge mode during list construction). The IBC merge selection between uni- or bi-predictive may be based on the candidate. One (e.g., only one) merge index may be used to signal the bi-predictive candidate.

In an example, a flag (e.g., an SPS, picture, slice, etc. flag) may enable/disable the bi-predictive derivation in the IBC BVP mode. A flag (e.g., another flag) may control the usage of bi-predictive candidate in the IBC merge list.

The IBC BVP mode may be modified to make the IBC BVP mode bi-predictive (e.g., which may not be intended).

BVP-merge candidates may be used as a source of bi-predictive information.

The bi-predictive candidates may be used to overcome this modification of the IBC BVP mode. For example, bi-predictive candidates may be generated in a BVP-merge mode. In that case, a plurality of (e.g., two) indices may be used (e.g., one for the BVP part and one for the merge part). The BVP-merge candidates may be stored as bi-predictive information (e.g., which may be reused in the IBC merge mode list construction). The IBC merge selection between uni- or bi-predictive may be given by the candidate. In this case, one (e.g., only one) merge index may be used to signal a bi-predictive candidate. In an example, a flag (e.g., an SPS, picture, slice, etc. flag) may enable/disable the usage of a bi-predictive candidate in the IBC merge list.

Feature(s) associated with signaling the merge index number are provided herein. A flag signaling the number of merge indices may be used (e.g., added at the picture, slice, or CU level). The flag may be called IBC_merge_index_number_minus_1. The flag may be 0 to indicate 1 merge index, or 1 to indicate 2 merge indices.

If the flag is 1, a bi-predictive candidate may be constructed by using two uni-predictive merge candidates. In this case, 2 indices may be signaled. If the flag is 0, a uni- or a bi-predictive candidate may be used (e.g., depending on the motion information retrieved at the merge list construction). In this case, one (e.g., only one) merge index may be used.

The constructed and the inherited bi-predictive candidates may be stored as bi-predictive information to be reused at IBC merge list construction.

Feature(s) described herein may be extended to other coding modes. For example, a bi-predictive IBC merge list may be shared with other coding modes (e.g., in addition to the IBC merge mode) such as: IBC-TM merge, IBC-CIIP, IBC-MBVD (MMVD for IBC), IBC-GPM, or any other coding modes that involve some IBC merge candidates that may become bi-predictive.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-16. (canceled)

17. A device for video decoding, the device comprising:
a processor configured to:
construct an intra block copy (IBC) merge list comprising a plurality of bi-predictive candidates and uni-predictive candidates;
receive, in video data, a merge index that indicates a candidate from the plurality of bi-predictive candidates and uni-predictive candidates;
select the candidate based on the merge index; and
decode a coding block based on the selected candidate.

18. The device of claim 17, wherein the processor being configured to construct the IBC merge list comprising the plurality of bi-predictive candidates and uni-predictive candidates comprises the processor being configured to:
add a first uni-predictive candidate and a second uni-predictive candidate to the IBC merge list;
determine a bi-predictive candidate based on the first uni-predictive candidate and the second uni-predictive candidate; and
add the bi-predictive candidate to the IBC merge list, wherein the selected candidate comprises the first uni-predictive candidate, the second uni-predictive candidate, or the bi-predictive candidate.

19. The device of claim 17, wherein the coding block is a first coding block, and the processor is further configured to:
determine that a block vector prediction merge mode is enabled for a second coding block; and
for the second coding block, generate a block vector prediction merge candidate based on a block vector part and a merge part, wherein the processor being configured to construct the IBC merge list comprising the plurality of bi-predictive candidates and uni-predictive candidates comprises the processor being configured to store the block vector prediction merge candidate as a bi-predictive candidate in the IBC merge list.

20. The device of claim 17, wherein the coding block is a first coding block, the merge index is a first merge index, and the processor is further configured to:
receive a first indication of a first value, wherein the first value indicates that the candidate indicated by the first merge index is to be selected from the plurality of bi-predictive candidates and uni-predictive candidates;
obtain a second coding block;
receive a second merge index that indicates a first uni-predictive candidate, a third merge index that indicates a second uni-predictive candidate, and a second indication of a second value, wherein the second value indicates for the first uni-predictive candidate and the second uni-predictive candidate to be used to generate a bi-predictive candidate;
generate the bi-predictive candidate based on the second merge index and the third merge index; and
decode the second coding block based on the bi-predictive candidate.

21. The device of claim 17, wherein the processor is further configured to generate the bi-predictive candidates using at least one of: an IBC block vector prediction (BVP) mode, a BVP-merge mode, an IBC template matching (IBC-TM) merge mode, an IBC combined inter-intra prediction (IBC-CIIP) mode, an IBC merge mode with block vector difference (IBC-MBVD) mode, or an IBC geometric partitioning mode (IBC-GPM).

22. The device of claim 17, wherein the processor is further configured to: receive an indication of whether the plurality of bi-predictive candidates are able to be used, wherein on a condition that the indication indicates that the plurality of bi-predictive candidates is not able to be used, the processor being configured to select the candidate based on the merge index comprises the processor being configured to select the candidate, from the uni-predictive candidates, based on the merge index.

23. The device of claim 17, wherein the coding block is a first coding block, the merge index is a first merge index, and the processor is further configured to:
store the IBC merge list;
receive a second merge index that indicates a second candidate from the plurality of bi-predictive candidates and uni-predictive candidates; and
decode a second coding block based on the stored IBC merge list and the second merge index.

24. A method for video decoding, the method comprising:
constructing an intra block copy (IBC) merge list comprising a plurality of bi-predictive candidates and uni-predictive candidates;
receiving, in video data, a merge index that indicates a candidate from the plurality of bi-predictive candidates and uni-predictive candidates;
selecting the candidate based on the merge index; and
decoding a coding block based on the selected candidate.

25. The method of claim 24, wherein constructing the IBC merge list comprising the plurality of bi-predictive candidates and uni-predictive candidates comprises:
adding a first uni-predictive candidate and a second uni-predictive candidate to the IBC merge list;
determining a bi-predictive candidate based on the first uni-predictive candidate and the second uni-predictive candidate; and
adding the bi-predictive candidate to the IBC merge list, wherein the selected candidate comprises the first uni-predictive candidate, the second uni-predictive candidate, or the bi-predictive candidate.

26. The method of claim 24, wherein the coding block is a first coding block, and the method further comprises:
determining that a block vector prediction merge mode is enabled for a second coding block; and
for the second coding block, generating a block vector prediction merge candidate based on a block vector part and a merge part, wherein constructing the IBC merge list comprising the plurality of bi-predictive candidates and uni-predictive candidates comprises storing the block vector prediction merge candidate as a bi-predictive candidate in the IBC merge list.

27. The method of claim 24, wherein the coding block is a first coding block, the merge index is a first merge index, and the method further comprises:
receiving a first indication of a first value, wherein the first value indicates that the candidate indicated by the first merge index is to be selected from the plurality of bi-predictive candidates and uni-predictive candidates;
obtaining a second coding block;
receiving a second merge index that indicates a first uni-predictive candidate, a third merge index that indicates a second uni-predictive candidate, and a second indication of a second value, wherein the second value indicates for the first uni-predictive candidate and the second uni-predictive candidate to be used to generate a bi-predictive candidate;
generating the bi-predictive candidate based on the second merge index and the third merge index; and
decoding the second coding block based on the bi-predictive candidate.

28. The method of claim 24, wherein the method further comprises generating the bi-predictive candidates using at least one of: an IBC block vector prediction (BVP) mode, a BVP-merge mode, an IBC template matching (IBC-TM) merge mode, an IBC combined inter-intra prediction (IBC-CIIP) mode, an IBC merge mode with block vector difference (IBC-MBVD) mode, or an IBC geometric partitioning mode (IBC-GPM).

29. The method of claim 24, wherein the method further comprises receiving an indication of whether the plurality of bi-predictive candidates are able to be used, wherein on a condition that the indication indicates that the plurality of bi-predictive candidates is not able to be used, selecting the candidate based on the merge index comprises selecting the candidate, from the uni-predictive candidates, based on the merge index.

30. The method of claim 24, wherein the coding block is a first coding block, the merge index is a first merge index, and the method further comprises:
storing the IBC merge list;
receiving a second merge index that indicates a second candidate from the plurality of bi-predictive candidates and uni-predictive candidates; and
decoding a second coding block based on the stored IBC merge list and the second merge index.

31. A device for video encoding, the device comprising:
a processor configured to:
construct a bi-predictive intra block copy (IBC) merge list comprising a plurality of bi-predictive candidates and uni-predictive candidates;
encode a coding block based on a candidate from the plurality of bi-predictive candidates and uni-predictive candidates; and
include, in video data, the encoded coding block and an indication of a merge index of the candidate.

32. The device of claim 15, wherein the processor being configured to construct the IBC merge list comprising the plurality of bi-predictive candidates and uni-predictive candidates comprises the processor being configured to:
add a first uni-predictive candidate and a second uni-predictive candidate to the IBC merge list;
determine a bi-predictive candidate based on the first uni-predictive candidate and the second uni-predictive candidate; and
add the bi-predictive candidate to the IBC merge list, wherein the candidate comprises the first uni-predictive candidate, the second uni-predictive candidate, or the bi-predictive candidate.

33. The device of claim 31, wherein the coding block is a first coding block, and the processor is further configured to:
determine that a block vector prediction merge mode is enabled for a second coding block; and
for the second coding block, generate a block vector prediction merge candidate based on a block vector part and a merge part, wherein the processor being configured to construct the IBC merge list comprising the plurality of bi-predictive candidates and uni-predictive candidates comprises the processor being configured to store the block vector prediction merge candidate as a bi-predictive candidate in the IBC merge list.

34. The device of claim 31, wherein the coding block is a first coding block, the merge index is a first merge index, the video data is first video data, and the processor is further configured to:
include, in the first video data, a first indication of a first value, wherein the first value indicates that the candidate indicated by the first merge index is to be selected from the plurality of bi-predictive candidates and uni-predictive candidates;
encode a second coding block based on the candidate from the plurality of bi-predictive candidates and uni-predictive candidates;
generate a bi-predictive candidate based on a first uni-predictive candidate and a second uni-predictive candidate;
encode the second coding block based on the bi-predictive candidate; and
include, in second video data, a second merge index that indicates the first uni-predictive candidate, a third merge index that indicates the second uni-predictive candidate, and a second indication of a second value, wherein the second value indicates that the second coding block was encoded based on the bi-predictive candidate generated based on the first uni-predictive candidate and the second uni-predictive candidate.

35. The device of claim 31, wherein the processor is further configured to generate the bi-predictive candidates using at least one of: an IBC block vector prediction (BVP) mode, a BVP-merge mode, an IBC template matching (IBC-TM) merge mode, an IBC combined inter-intra prediction (IBC-CIIP) mode, an IBC merge mode with block vector difference (IBC-MBVD) mode, or an IBC geometric partitioning mode (IBC-GPM).

36. The device of claim 31, wherein the processor is further configured to include, in the video data, an indication of whether the plurality of bi-predictive candidates are able to be used.
